(19) United States
(12) Patent Application Publication
(10) Pub. No.: US 2025/0310069 A1
(43) Pub. Date: Oct. 2, 2025

(54) METHOD AND COMMUNICATION APPARATUS

(71) Applicant: CANON KABUSHIKI KAISHA, Tokyo (JP)

(72) Inventor: YOICHI MAEDA, Kanagawa (JP)

(21) Appl. No.: 19/089,776

(22) Filed: Mar. 25, 2025

(30) Foreign Application Priority Data
Apr. 2, 2024 (JP) 2024-059333

(51) Int. Cl. H04L 5/00; H04W 24/10

(52) U.S. Cl. CPC H04L 5/0098; H04W 24/10

(57) ABSTRACT

A method of providing a communication function as a master node based on dual connectivity includes performing first selection processing of selecting a base station in a second frequency band as a secondary node base station to be used for communication with an UE, performing second selection processing of selecting, in a case where a first frequency band is used with the UE, and a base station in the second frequency band that is higher than the first frequency band is not present and a base station in the first frequency band is present in a surrounding area that are base stations which satisfy a criterion, the base station in the first frequency band as a secondary node base station to be used for communication with the UE, and transmitting an S-NODE ADDITION REQUEST to the base station selected by the first selection processing or the second selection processing.

### BACKGROUND

### Technical Field

The present disclosure relates to a method of providing a communication function and to a communication apparatus.

### Description of the Related Art

Cellular communication standards have been established in Third Generation Partnership Project (3GPP (registered trademark)). Standardization of an integrated access and backhaul (IAB) in which an access line and a backhaul line are integrated has been advanced in the cellular communication standards in 3GPP (hereinafter, referred to as 3GPP standards) (see PCT Japanese Translation Patent Publication No. 2019-534625). In the IAB, a wireless resource used for an access line between a base station (gNB) and user equipment (UE) is also used in a backhaul line. By using the IAB for the backhaul line, a relay station (IAB node) can relay communication between the base station (IAB donor) and the UE by a wireless line, and it is possible to improve connectivity of a wireless access network. For example, in the IAB, a wireless resource in a millimeter wave band such as a 28 GHz band is mainly used. As a frequency band to be used in the IAB, 700 MHz to 3.5 GHz radio waves are used in 4GLTE, and 3.6 GHz to 4.6 GHz radio waves are used in Sub6. In the millimeter wave band, 27 GHz to 29.5 GHz radio waves are used. By using the IAB, a relay apparatus (IAB node) can relay communication between a base station apparatus (IAB donor) and a terminal apparatus by a wireless line, and as compared with a case where a wired line such as an optical fiber is used, it is possible to expand an area coverage in an inexpensive manner.

So far, specification establishment has been implemented with regard to a fixed base station (IAB node involving no movement) up to Release 17 that is a 3GPP standardization phase.

The current 3GPP has progressed to a phase of Release18. In this phase, discussions are actively taking place on a vehicle mounted relay that is a use case and MBSR as specification establishment of an architecture or protocol for realizing the use case. MBSR is an abbreviation of mobile base station relay, which may also be referred to as mobile IAB. By using the MBSR, in addition to provision of a satisfactory communication service in a vehicle, improvement in a communication quality in an area locally having a poor signal condition or a congested area is expected.

In 3GPP, a technique called dual connectivity (DC) has been also standardized. According to the DC, a UE is connected at the same time to two base stations called a master node (MN) and a secondary node (SN). Then, the UE uses component carriers supported by the two base stations to perform communication, so that it is possible to increase communication speeds and enhance connection redundancy.

### SUMMARY OF THE INVENTION

A communication apparatus according to an aspect of the present disclosure is a communication apparatus that operates as a master node based on dual connectivity, the communication apparatus including a frequency selection unit configured to select, in a case where a first frequency band is used with user equipment operating as a terminal, a second frequency band that is different from the first frequency band as a frequency band to be used between a secondary node and the user equipment, and a transmission unit configured to transmit the frequency band selected by the frequency selection unit to a candidate of the secondary node to communicate with the user equipment.

Further features of the present disclosure will become apparent from the following description of exemplary embodiments with reference to the attached drawings.

### BRIEF DESCRIPTION OF THE DRAWINGS

FIG. 1 illustrates a configuration example of a wireless communication system (part 1).

FIG. 2 illustrates a hardware configuration of a base station/IAB donor.

FIG. 3 illustrates a software function of the base station/IAB donor.

FIG. 4 is a DC connection sequence controlled by an MN base station.

FIG. 5 is a flowchart of the MN base station/IAB donor according to the present embodiment.

FIG. 6 illustrates a configuration example of the wireless communication system (part 2).

FIG. 7 is a DC connection sequence controlled by the IAB donor.

FIG. 8 illustrates a BAP message format (for notification on a selected frequency band).

### DESCRIPTION OF THE EMBODIMENTS

Hereinafter, each of embodiments will be described in detail with reference to the accompanying drawings. In the following explanation, a “number ***” in TS *** denotes a technical specification number in Third Generation Partnership Project (3GPP®) standards.

### Description on DC Operation Based on 3GPP Specifications

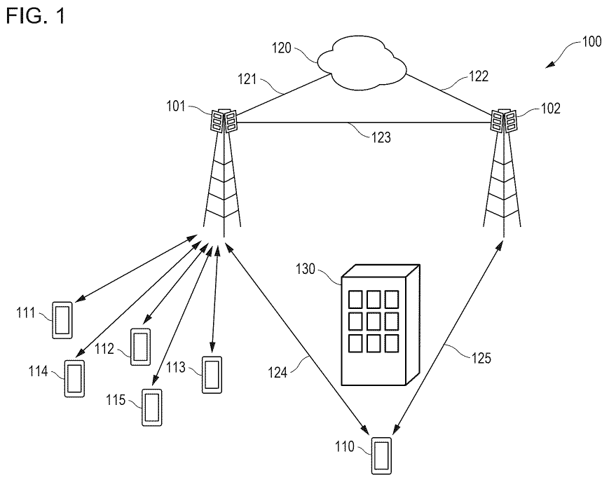

FIG. 1 illustrates a configuration example of a wireless communication system according to the present embodiment. A system 100 is constituted by a plurality of UEs 110 to 115, a core network 120, base stations 101 and 102, and an obstacle 130 such as a building. The base stations 101 and 102 is connected to the core network 120 via wired links 121 and 122 (optical fiber or other wired components). The base stations 101 and 102 are also connected to each other by a wired link 123.

In a case where dual connectivity (DC) connection is established, the UE 110 connects to the base station 101 serving as a master node (MN) via a wireless MCG link 124 and at the same time connects to the base station 102 serving as a secondary node (SN) via a wireless SCG link 125. A wide bandwidth and a high reliability can be realized based on redundant transmission from the different base stations. MCG is an abbreviation of master cell group, and SCG is an abbreviation of secondary cell group.

However, for example, in a case where a millimeter wave frequency band is used in both the wireless MCG link 124 and the wireless SCG link 125, a radio wave strength attenuates due to an influence of the obstacle 130, and furthermore, radio wave interference or disconnection may occur between the base station and the terminal. In addition, in a case where a Sub6 frequency band is being used in both the wireless MCG link 124 and the wireless SCG link 125, for example, when a large number of UEs 111 to 115 and the like newly connect to the base stations 101 and 102 during the DC to perform high speed communication, the line may become congested, and the bandwidth may be insufficient.

In addition, even in a case where the connection based on the DC has been executed, due to fluctuations in a wireless communication environment because of movements of terminals (such as a UE, a mobile base station relay (MBSR), and an integrated access and backhaul (IAB) node), the connection may become unstable such as slowing down of communication speeds.

For example, while a terminal is connected in Sub6, when a plurality of other terminals enter a cover area of the same base station to start communication, an available bandwidth of the base station may become insufficient, and a line status may be congested to cause the communication speeds to significantly slow down. In addition, when the terminal is wirelessly connected using a millimeter wave frequency band, millimeter waves have a strong straight-line propagation characteristic and such a tendency that communication breaks when affected by an obstacle such as a building, and it becomes difficult to continue stable communication as disconnection or the like may occur.

In view of the above, according to the present embodiment, there is provided a scheme for performing control such that DC connection can be realized in a mode in which the stable communication is likely to be maintained. Hereinafter, the present disclosure will be specifically described with reference to the drawings.

### Hardware Configuration

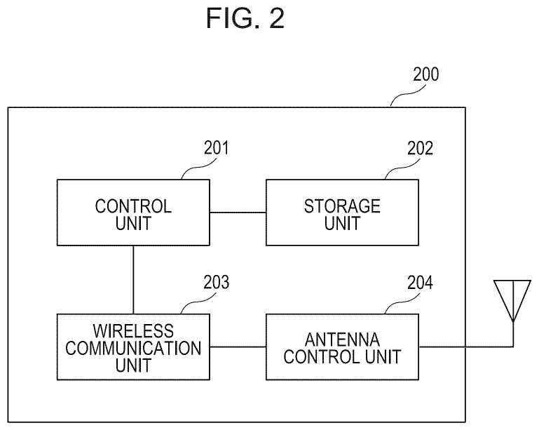

FIG. 2 is a hardware function block diagram of a base station (including an IAB donor) according to the present embodiment.

The base station is constituted by hardware including a control unit 201, a storage unit 202, a wireless communication unit 203, and an antenna control unit 204.

The control unit 201 controls an entire apparatus by executing a control program stored in the storage unit 202.

The storage unit 202 stores a control program to be executed by the control unit 201 and various types of information such as information of user equipment (UE) to be connected and a connection strength with the other base station (including an IAB donor). The wireless communication unit 203 is a wireless communication unit configured to perform cellular network communication such as LTE compliant with 3GPP standards or 5G. It is noted herein that the description will be provided where the cellular network communication executed by the wireless communication unit is 5G, but the present embodiment is applicable to standards other than 5G (for example, 5G Advanced, 6G, or the like). That is, the base station (including an IAB donor) described in the present embodiment is a next generation NodeB (gNB) in the 5G standards. It is noted that in a case where the present embodiment is applied to 6G, the base station may be a 6gNB/6GNB. In addition, the base station serving as the MN may be a gNB, and the base station serving as the SN may be a 6gNB. That is, the present embodiment can be applied to the DC based on different radio access technologies (RATs) such as 5G and 6G.

The antenna control unit 204 controls an antenna to be used for wireless communication executed in the wireless communication unit 203.

### Software Configuration

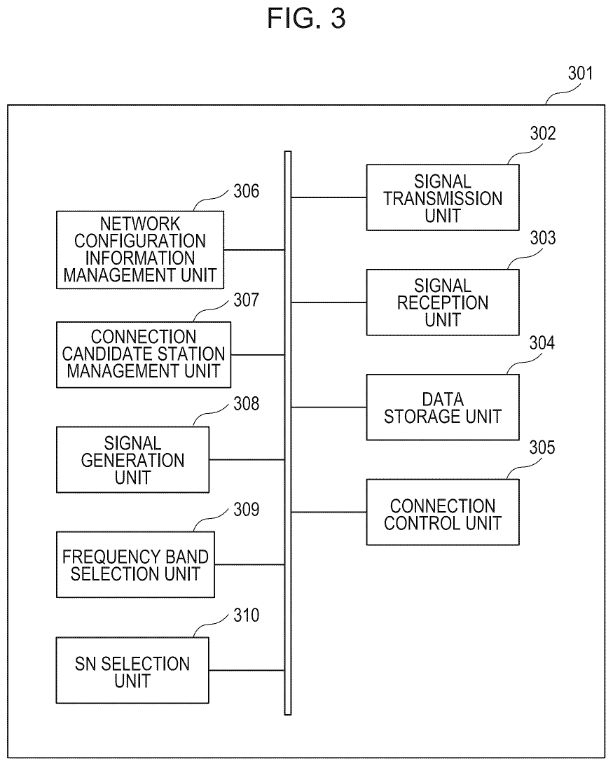

FIG. 3 illustrates a software function of the base station (including an IAB donor) according to the present embodiment.

A software functional block 301 is stored in the storage unit 202 and executed in the control unit 201. The software functional block 301 includes a signal transmission unit 302, a signal reception unit 303, a data storage unit 304, a connection control unit 305, a network configuration information management unit 306, a connection candidate station management unit 307, and a signal generation unit 308. The software functional block 301 further includes a frequency band selection unit 309 and a SN selection unit 310. The signal transmission unit 302 and the signal reception unit 303 control the wireless communication unit 203 via the control unit 201 to execute cellular network communication such as LTE compliant with 3GPP standards or 5G between the other base station (including an IAB donor) and the UE.

In addition, the connection control unit 305 controls the antenna control unit 204 via the control unit 201 at the time of wireless communication.

The data storage unit 304 controls and manages the storage unit 202 that is an entity and stores and holds software itself, and information of connection with other base stations (IAB nodes in the case of the IAB donor), information related to the UE, and the like. Information between nodes can be collected through a reporting signal or a communication packet (hereinafter, a BAP control packet) associated with various types of control protocol data units (PDUs) of a backhaul adaptation protocol (BAP). Information from the UE can be collected through a radio resource control (RRC) message, for example.

The network configuration information management unit 306 manages configuration information of an IAB network, which is configured by including its own station in the case of the IAB donor. Type information of the UE, the IAB node, and the MBSR which issue a connection request to its own station is also managed by the network configuration information management unit 306. The information generated by the network configuration information management unit 306 is to be used when a connection control signal is generated in the connection control unit 305.

The signal generation unit 308 generates various types of signals to be wirelessly transmitted. The various types of generated signals are transmitted by the signal transmission unit 302.

The frequency band selection unit 309 selects a frequency band in which the UE or the IAB node connects to an SN base station when operating as an MN base station.

The SN selection unit 310 selects, as the SN base station, a base station which can use the frequency band selected by the frequency band selection unit 309.

### First Embodiment: DC Connection Controlled by MN Base Station

In view of the issues described with reference to FIG. 1, a method for providing the DC connection based on the frequency band by the MN base station will be described.

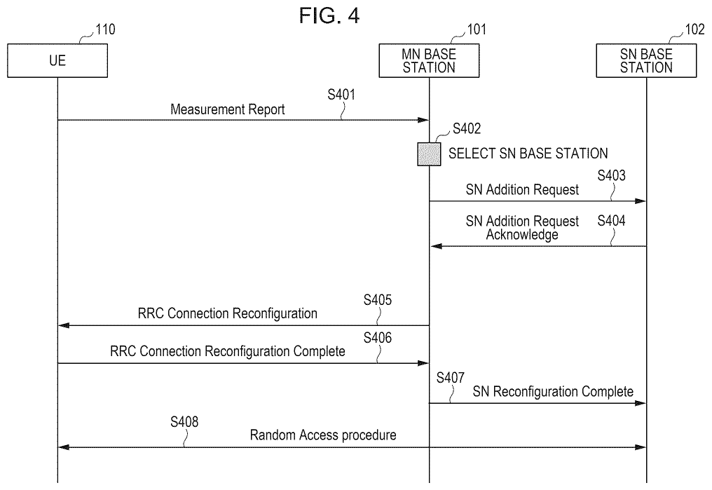

FIG. 4 illustrates a DC connection sequence controlled by the MN base station according to the present embodiment. FIG. 4 illustrates a sequence of SN addition processing based on a general SN addition processing sequence in 3GPP standards according to the present embodiment. This sequence assumes that the UE 110 is connected to the MN base station 101.

The UE 110 transmits Measurement Report to the MN base station 101 (S401). The UE 110 puts, in a Measurement Report, a list in which radio wave qualities of base stations (neighboring cells) in a surrounding area which have been detected by the UE 110 are summarized and notifies the MN base station 101 of the report on a regular basis or by using a specific condition as a trigger. The UE 110 puts, in Measurement Report, frequency bands that can be used by the base stations in the surrounding area and notifies the MN base station 101 of the report on a regular basis or by using a specific condition as a trigger.

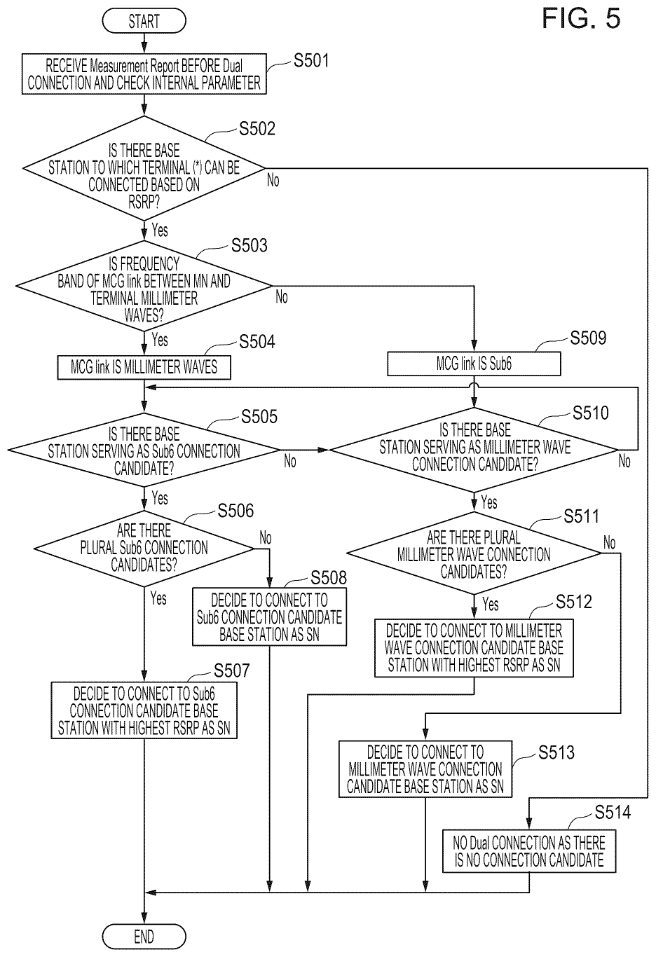

The MN base station 101 which has received Measurement Report in S401 evaluates a connection strength of the UE 110, decides an SN selection method, and selects an SN (S402). A specific SN selection method will be illustrated in a flowchart of FIG. 5 described below.

A subsequent procedure is the same as a general SN addition processing sequence in 3GPP standards.

The MN base station 101 transmits SN Addition Request to the base station 102 serving as an SN candidate (S403). At this time, in S403, a message including a parameter of the frequency band selected in S402 is transmitted to the SN base station selected in S402. In addition, for example, a parameter such as S-NODE ADDITION REQUEST in a transmission and reception (Xn) message format between base stations which is described in TS.38.423 V17.0.6 may be used as the parameter. In this case, the MN base station 101 may set the selected frequency band in a parameter of Index to RAT/Frequency Selection Priority to be transmitted to the base station 102 serving as the SN candidate.

The base station 102 serving as the SN candidate which has received SN Addition Request (S403) transmits SN Addition Request Acknowledge to the MN base station 101 (S404). The base station 102 serving as the SN candidate recognizes that the same frequency band as the frequency band requested by the MN base station 101 is used.

The MN base station 101 transmits RRC ConnectionReconfiguration to the UE 110 (S405).

The UE 110 transmits RRC ConnectionReconfigurationComplete to the MN base station 101 (S406).

The MN base station 101 transmits SN ReconfigurationComplete to the SN base station 102 (S407).

Finally, Random Access procedure is performed between the UE 110 and the SN base station 102 to establish connection (S408).

FIG. 5 is a flowchart of the MN base station/the IAB donor according to the present embodiment. The MN base station selects the SN base station 102 which can use a frequency band that is different from the frequency band used for the connection with the UE. According to this, high reliability and high speed communication can be realized.

After Measurement Report (S401) is received, the MN base station 101 analyzes a radio wave strength of a reception cell (S501). Here, a data format of Measurement Report is specified in TS38.331 of 3GPP specifications. Measurement Report describes therein MeasResults serving as information related to radio wave qualities of base stations in a surrounding area. MeasResultListNR serving a list of information related to radio wave qualities of neighboring cells is included in MeasResults. MeasResultListNR includes MeasResultNR that is information related to radio wave qualities of neighboring cells. These are prepared for each of base stations detected by the UE. MeasResultNR includes PhysCellID that is an ID to identify a base station (cell) and MeasResult (RSRP, RSRQ, and SINR) serving as information related to radio wave qualities. RSRP is an abbreviation of reference signal received power. RSRQ is an abbreviation of reference signal received quality. SINR is an abbreviation of signal to interference plus noise power ratio.

A base station to which the UE can be connected is determined based on the radio wave qualities of the neighboring cells (S502). For example, it is determined that the connection can be established when RSRP is greater than or equal to a threshold. In a case where there is no base station which can be determined as connectable, the DC is not possible and is not implemented (S514). Next, the MN base station 101 checks whether the frequency band used for the communication with the UE 110 is millimeter waves or a frequency band other than millimeter waves (S503).

In S503, in a case where the millimeter wave frequency band is used, that is, a case where it is confirmed that the MN base station 101 is connected to the UE 110 using the millimeter wave frequency band (S504), the flow proceeds to S505. The MN base station 101 checks whether a base station that is connectable in the Sub6 frequency band is present among the connectable base stations based on Measurement Report (S505). That is, it is checked whether a base station that is connectable in the Sub6 frequency band is present based on the frequency bands of the cells with PhysCellIDs (used frequency bands of the connectable base stations) notified of by Measurement Report (S505). It is noted that the MN base station 101 can check which cell uses what frequency band by referring to a correspondence list between PhysCellIDs and the frequency bands or the like. When a base station connectable in the Sub6 frequency band is present, it is checked whether the base station includes a plurality of base stations (S506). When a single base station is present, it is decided that connection is to be established with the base station as the SN base station 102 (S508). In a case where a plurality of base stations are present, a base station with a highest RSRP is selected, and it is decided that connection is to be established with the base station as the SN base station 102 (S507).

It is however noted that in S505, in a case where a base station in the Sub6 frequency band is not present among the connectable base stations, a base station in millimeter waves that is the same as the MN base station 101 is selected as the SN base station 102 to implement the DC connection (the flow proceeds to S510 described below).

In a case where it is confirmed that the MN base station 101 is connected to the UE 110 using the Sub6 frequency band, “NO” in S503. In a case where the flow proceeds to S509, the flow then proceeds to S510.

The MN base station 101 checks whether a base station connectable in the millimeter wave frequency band is present among the connectable base stations based on the frequency bands of the cells with PhysCellIDs notified of in Measurement Report (S510). When a base station connectable in the millimeter wave frequency band is present, it is checked whether the base station includes a plurality of base stations (S511). When a single base station is present, it is decided that connection is to be established with the base station as the SN base station 102 (S513). In a case where a plurality of base stations are present, a base station with a highest RSRP is selected, and it is decided that the DC connection is established with the base station as the SN base station 102 (S512). It is however noted that in S510, in a case where a base station in the millimeter wave frequency band is not present among the connectable base stations, the base station in Sub6 that is the same as the MN base station 101 is selected to implement the DC connection (the flow proceeds to S505). It is noted that the Sub6 frequency band in the description of FIG. 5 may be read as a 4GLTE frequency band.

In this manner, according to the present embodiment, the MN base station 101 can preferentially select a frequency band different from the frequency band used in the communication with the UE 110 and transmit information indicating the selected frequency band to the base station 102 serving as the SN candidate.

### Second Embodiment: Description on DC Operation in IAB Configuration Based on 3GPP Specifications

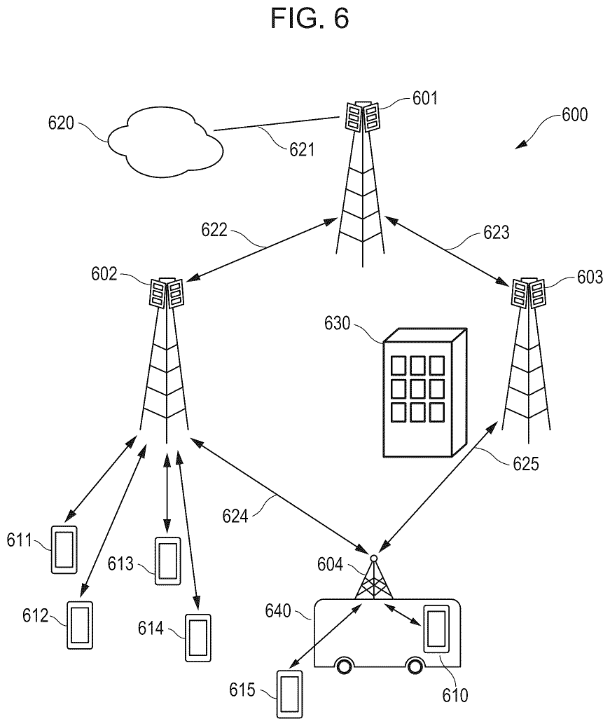

FIG. 6 illustrates a configuration example (part 2) of the wireless communication system according to the present embodiment.

A system 600 is constituted by a plurality of UEs 610 to 615, a core network 620, base stations 601 to 604 (an IAB donor 601, IAB nodes 602 and 603 under the IAB donor, and an MBSR 604) each of which has a function as an IAB, and an obstacle 630 such as a building. The IAB donor 601 is connected to the core network 620 via a wired link 621 (optical fiber or other wired components). The IAB donor 601 is connected to the IAB nodes 602 and 603 under the IAB donor by way of a wireless backhaul link to form an IAB topology. According to the present embodiment, the IAB donor 601 and the IAB nodes 602 and 603 are 5G base stations (gNBs) including an addition function to support an IAB function as defined by a specification of 3 GPP TS 38.300 v 17.6.0.

The MBSR 604 is mounted to a vehicle 640 to provide a network coverage and a capacity expansion. The IAB donor 601 can communicate with not only an on-board UE like a remote UE 610 but also the UE 615 outside a vehicle. Therefore, the IAB donor 601 and the MBSR 604 form a backhaul network or an IAB network which accommodates the UE 610 and the UE 615 or an IAB topology. IAB specifications are specified in several 3GPP standard documents as follows.
TS 38.300 RAN architecture (V 17.6.0)
TS 38.321 MAC protocol (V 17.6.0)
TS 38.331 Radio Resource Control (RRC) protocol (V 17.6.0)
TS 38.340 backhaul adaptation protocol layer (V 17.5.0)
TS 38.401 RAN architecture (V 17.6.0)
TS 38.423 Xn application protocol (V 17.5.0)
TS 38.473 F 1 application protocol (V 17.6.0)

In a case where the MBSR 604 performs the DC connection in this IAB configuration, the MBSR 604 is connected to the IAB node 602 serving as an MN via a wireless MCG link 624. At the same time, the MBSR 604 is also connected to the IAB node 603 serving as an SN via a wireless SCG link 625, so that a wide bandwidth can be realized through simultaneous communication from different IAB nodes (base stations).

However, for example, in a case where the millimeter wave frequency band is used in both the wireless MCG link 624 and the wireless SCG link 625, the following situation may occur. That is, since the radio wave strength attenuates due to the influence of the obstacle 630, radio wave interference or disconnection may occur in the wireless SCG link 625 between the IAB node 603 and the MBSR 604. In addition, when the Sub6 frequency band is used in both the wireless MCG link 624 and the wireless SCG link 625, for example, an issue may occur that a large number of UEs 611 to 614 may connect to the IAB nodes 602 and 603 to perform high speed communication at the same time, so that the line becomes congested.

### Second Embodiment: DC Connection Controlled by IAB Donor

For the issue described in the wireless communication system in FIG. 6, a method for providing the DC connection based on the frequency band by the IAB donor will be described.

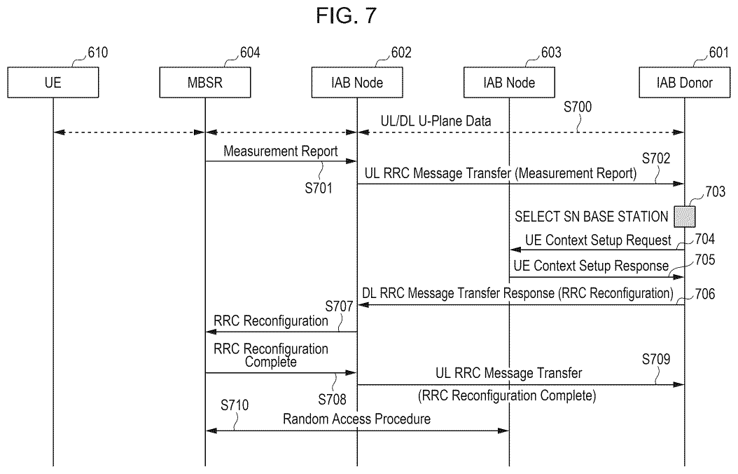

FIG. 7 illustrates a DC connection sequence controlled by the IAB donor 601 according to the present embodiment.

FIG. 7 illustrates a sequence of redundancy procedures of a topology in a CU of an IAB node according to the present embodiment based on a general SN addition processing sequence (see TS 38.401, Chapter 8.2.4) in 3GPP standards. This sequence assumes that the MBSR 604 is connected to the IAB donor 601 via the IAB node 602.

In the case of downlink (DL) transmission of U-Plane data, the following sequence is carried out. That is, the DL data is transmitted in a backhaul link from the IAB donor 601 via the IAB node 602 up to the MBSR 604, and the DL data is transmitted from the MBSR 604 to the UE 610 through Uu similarly as in the wireless communication between the base station and the UE (S700). In the case of uplink (UL) transmission of U-Plane data, after the transmission in a Uu section from the UE 610 to the MBSR 604, the data is transmitted from the MBSR 604 in the backhaul link via the IAB node 602 to the IAB donor 601 (S700).

The MBSR 604 transmits Measurement Report to the IAB node 602 (S701). Measurement Report includes radio wave qualities of base stations (including an IAB donor and an IAB nodes) in a surrounding area.

The IAB node 602 serving as a parent node of a first path which has received Measurement Report in S701 performs the following procedure. That is, the IAB node 602 transmits UL RRC Message Transfer to transfer Measurement Report to the IAB donor 601 (S702).

The IAB donor 601 which has received Measurement Report evaluates a connection strength of the MBSR 604, decides a selection method for a parent node of a second path of the MBSR 604, and selects the parent node of the second path (S703). A specific selection method for the parent node of the second path is control equivalent to a method obtained by replacing the MN base station 101 with the IAB donor 601 in the above-described flowchart of FIG. 5.

The subsequent sequence is similar to a topology redundancy procedure sequence in a general CU in 3GPP standards.

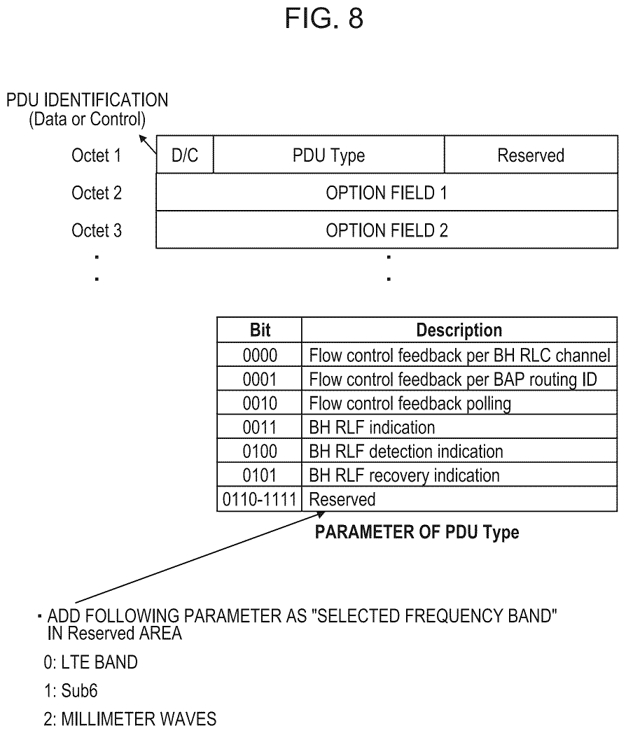

The IAB donor 601 transmits UE Context Setup Request to the IAB node 603 serving as a candidate of the parent node of the second path (S704). At this time, in S704, a message including a parameter of the frequency band selected in S703 is transmitted to the parent node of the second path selected in S703. For example, an existing parameter “RAT-Frequency Priority Information” in S704 may be used, or the parameter may be added in a reserved area to be transmitted. In addition, as the message in which the frequency band selected by the IAB donor 601 is transmitted to the parent node of the second path, the following method may be used. That is, a parameter of the “selected frequency band” may be added in a reserved area of PDUType in a BAP message of FIG. 8, and the frequency band of the connection demand may be transmitted. BAP is an abbreviation of backhaul adaptation protocol.

The IAB node 603 serving as the candidate of the parent node of the second path which has received UE Context Setup Request transmits UE Context Setup Response to the IAB donor 601 (S705). The IAB node 603 recognizes that the same frequency band as the frequency band requested by the IAB donor 601 is used.

The IAB donor 601 transmits DL RRC Message Transfer Response (RRC Reconfiguration) to the IAB node 602 serving as the parent node of the first path (S706).

The IAB node 602 serving as the parent node of the first path transmits RRC ConnectionReconfiguration to the MBSR 604 (S707).

The MBSR 604 transmits RRC Connection Reconfiguration Complete to the IAB node 602 serving as the parent node of the first path (S708).

The IAB node 602 transmits UL RRC Message Transfer (RRC Reconfiguration Complete) to the IAB donor 601 (S709).

Thereafter, Random Access procedure is performed between the MBSR 604 and the IAB node 603 serving as the candidate of the parent node of the second path to establish connection (S710).

As described above, according to an aspect of the present disclosure, it is possible to provide the scheme with which the DC connection can be realized in a mode in which the stable connection is likely to be maintained.

In addition, according to the present embodiment, a recording medium having recorded thereon a program code of software for realizing the above-described functions may be supplied to a system or an apparatus. Then, a computer (a central processing unit (CPU) or a microprocessor unit (MPU)) of the system or the apparatus may read and execute the program code recorded in the recording medium. In this case, the program code itself read from the recording medium realizes the above-described embodiments, and the recording medium having recorded thereon the program code constitutes the present embodiment. In addition, the above-described embodiments can be realized by a circuit (for example, an ASIC or an FPGA) configured to realize one or more functions. It is noted that ASIC is an abbreviation of application specific integrated circuit.

FPGA is an abbreviation of field programmable gate array. In addition, by causing a hardware circuit and a processor such as a CPU or an MPU to cooperate, some or all of the various types of processing described in the above flowcharts can be realized.

For example, a flexible disk, a hard disk, an optical disk, an opto-magnetic disk, a CD-ROM, a CD-R, a magnetic tape, a non-volatile memory card, a ROM, a DVD, or the like can be used as a storage medium configured to supply a program code.

In addition, not only the above-described functions may be realized by executing the program code read by the computer, but also an OS running on the computer performs some or all of actual processes based on instructions of the program code to realize the above-described functions. OS is an abbreviation of operating system.

Furthermore, the program code read from the recording medium is written to a memory included in a function expansion unit which is connected to a function expansion board inserted to a computer or connected to the computer.

Then, based on the instructions of the program code, a CPU included in the function expansion board or the function expansion unit may perform some or all of the actual processes to realize the above-described functions. It is noted that when each of separate entities of radio unit/distributed unit/central unit (RU/DU/CU) operates in a collaborative manner, it is possible to provide a function as the base station of the above-described embodiments. In this case, individually, the RU performs control or the like on an antenna and radio waves, the DU performs modulation and demodulation, media access control (MAC), or the like, and the CU performs control on RU/DU under itself, bridging to a core network, or the like. In this case, the control or the like as an MN is executed by a CU constituting a base station and an IAB CU constituting an IAB donor which act as main entities. It is noted that at this time, it is sufficient when the CU and the IAB CU exchange control signals with the DU to which a network such as a fiber network is connected and the RU connected to the DU to realize the collaborative operation. It is noted that in a case where the present disclosure is applied to a case where DC connection including nodes of 6gNBs which support 6G is implemented, such a configuration can be adopted where for an interface between base stations, an Xn2 interface or the like which specifies communication between 6G base stations is used instead of an Xn interface. That is, in a case where an SN is a 6gNB, an MN may perform communication of a message such as S-NODE ADDITION REQUEST with the SN using an Xn2 message. It is noted that names of the interface and the message are examples and are not limited to these.

The first embodiment and the second embodiment have been described based on an assumption of a case where the SN addition processing is performed, but the first embodiment and the second embodiment can also be applied to a case where SN change processing is performed.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-059333, filed Apr. 2, 2024, which is hereby incorporated by reference herein in its entirety.

What is claimed is:

1. A method of providing a communication function as a master node based on dual connectivity, the method comprising:
performing first selection processing of selecting, in a case where a first frequency band is used with user equipment operating as a terminal, and a base station in a second frequency band that is higher than the first frequency band and a base station in the first frequency band are present in a surrounding area that are base stations which satisfy a criterion, the base station in the second frequency band as a secondary node base station to be used for communication with the user equipment;
performing second selection processing of selecting, in a case where the first frequency band is used with the user equipment, and a base station in a second frequency band that is higher than the first frequency band is not present and a base station in the first frequency band is present in a surrounding area that are base stations which satisfy the criterion, the base station in the first frequency band as a secondary node base station to be used for communication with the user equipment; and
transmitting an S-NODE ADDITION REQUEST message that is an Xn message to the base station selected by the first selection processing or the second selection processing.

2. The method according to claim 1, further comprising:
performing third selection processing of selecting, in a case where the second frequency band is used with the user equipment, and the base station in the first frequency band and the base station in the second frequency band are present in a surrounding area that are base stations which satisfy the criterion, the base station in the first frequency band as a secondary node base station to be used for communication with the user equipment.

3. The method according to claim 1, further comprising:
transmitting, to a base station serving as a candidate of the secondary node that is a base station which satisfies the criterion, information indicating that a frequency band to be used for connection with the user equipment is the second frequency band.

4. The method according to claim 3, wherein
the information is included in the S-NODE ADDITION REQUEST message.

5. The method according to claim 1, further comprising:
determining whether a base station is the base station which satisfies the criterion based on Measurement Report received from the user equipment.

6. The method according to claim 1, wherein
each of the first frequency band and the second frequency band is any different one of millimeter wave, Sub6, and 4GLTE frequency bands.

7. The method according to claim 3, wherein
the information is transmitted using an Xn message.

8. A communication apparatus that functions as a master node based on dual connectivity, the communication apparatus comprising:
at least one memory that stores a set of instructions; and
at least one processor that executes the instructions, the instructions, when executed, causing the communication apparatus to perform operations comprising:
performing first selection processing of selecting, in a case where a first frequency band is used with user equipment operating as a terminal, and a base station in a second frequency band that is higher than the first frequency band and a base station in the first frequency band are present in a surrounding area that are base stations which satisfy a criterion, the base station in the second frequency band as a secondary node base station to be used for communication with the user equipment;
performing second selection processing of selecting, in a case where the first frequency band is used with the user equipment, and a base station in a second frequency band that is higher than the first frequency band is not present and a base station in the first frequency band is present in a surrounding area that are base stations which satisfy the criterion, the base station in the first frequency band as a secondary node base station to be used for communication with the user equipment; and
transmitting an S-NODE ADDITION REQUEST message that is an Xn message to the base station selected by the first selection processing or the second selection processing.
